(19) United States
(12) Patent Application Publication
(10) Pub. No.: US 2023/0419609 A1
(43) Pub. Date: Dec. 28, 2023

(54) SELF-SUPERVISED 3D POINT CLOUD ABSTRACTION

(71) Applicant: InterDigital Patent Holdings, Inc., Wilmington, DE (US)

(72) Inventors: Ruoyu Wang, New York, NY (US); Muhammad Asad Lodhi, Highland Park, NJ (US); Jiahao Pang, Plainsboro, NJ (US); Dong Tian, Boxborough, MA (US)

(21) Appl. No.: 18/036,834

(22) PCT Filed: Nov. 12, 2021
(86) PCT No.: PCT/US2021/059076

§ 371 Date: May 12, 2023

Related U.S. Application Data
(60) Provisional application No. 63/113,424, filed on Nov. 13, 2020.

(51) Int. Cl. G06T 17/20; G06T 19/20

(52) U.S. Cl. CPC G06T 17/20; G06T 19/20; G06T 2219/2004

(57) ABSTRACT

A method for adaptively abstracting a point cloud includes initializing a set of primitives associated with a query shape and a set of query parameters. For each primitive a local point set is accessed using the set of query parameters and the query shape associated with the primitive. For each local point set, using a first neural network, a descriptor vector comprising a sub-vector for a primitive update and a sub-vector for a local descriptor is determined. The set of primitives is updated based on the descriptor vector for each local point set.

### 1. TECHNICAL FIELD

The present principles generally relate to the domain of point cloud processing. The present document is also understood in the context of the analysis, the interpolation, the representation and the understanding of point cloud signals.

### 2. BACKGROUND

The present section is intended to introduce the reader to various aspects of art, which may be related to various aspects of the present principles that are described and/or claimed below. This discussion is believed to be helpful in providing the reader with background information to facilitate a better understanding of the various aspects of the present principles. Accordingly, it should be understood that these statements are to be read in this light, and not as admissions of prior art.

Point cloud is a data format used across several business domains including autonomous driving, robotics, AR/VR, civil engineering, computer graphics, and the animation/movie industry. 3D LIDAR sensors have been deployed in self-driving cars, and affordable LIDAR sensors are included with, for example, Apple iPad Pro 2020 and Intel Real Sense LIDAR camera L515. With advances in sensing technologies, three-dimensional (3D) point cloud data has become more practical and is expected to be a valuable enabler in the applications mentioned.

At the same time, point cloud data may consume a large portion of network traffic, e.g., among connected cars over a 5G network, and immersive communications (virtual or augmented reality (VR/AR)). Point cloud understanding and communication would essentially lead to efficient representation formats. In particular, raw point cloud data need to be properly organized and processed for the purposes of world modeling and sensing.

Furthermore, point clouds may represent a sequential scan of the same scene, which contains multiple moving objects. These are called dynamic point clouds as compared to static point clouds captured from a static scene or static objects. Dynamic point clouds are typically organized into frames, with different frames being captured at different times.

3D point cloud data are essentially discrete samples of the surfaces of objects or scenes. To fully represent the real world with point samples, in practice, a large number of points is required. For instance, a typical VR immersive scene contains millions of points, while point cloud maps typically contain hundreds of millions of points. Therefore, the processing of such large-scale point clouds is computationally expensive, especially for consumer devices that have limited computational power, e.g., smartphones, tablets, and automotive navigation systems.

Raw point cloud data obtained from sensing modalities can be sparse and noisy and need first to be processed for downstream tasks such as summarization, segmentation, compression, classification, etc. To facilitate these downstream tasks, methods and apparatuses performing an efficient point cloud abstraction is necessary to provide a new way to represent the raw point cloud as a combination of explicit (geometric primitives) and implicit (abstract codewords) features.

### 3. SUMMARY

The following presents a simplified summary of the present principles to provide a basic understanding of some aspects of the present principles. This summary is not an extensive overview of the present principles. It is not intended to identify key or critical elements of the present principles. The following summary merely presents some aspects of the present principles in a simplified form as a prelude to the more detailed description provided below.

The present principles relate to a method for adaptively abstracting a point cloud by initializing a set of primitives associated with a query shape and a set of query parameters. For each primitive a local point set using the set of query parameters and the query shape associated with the primitive is accessed. For each local point set, using a first neural network, a descriptor vector comprising a sub-vector for a primitive update and a sub-vector for a local descriptor is determined. The set of primitives is updated based on the descriptor vector for each local point set.

The present principles also relate to a device comprising a processor associated with a memory configured to implement the steps of the method above.

The present principles also relate to a method for reconstructing a point cloud from a set of primitives by determining a sampling distribution in a space of the point cloud based on the primitives. Distribution parameters, based on the local descriptor, are determined using a first neural network. Points of the primitives are determined from the distribution parameters. The set of primitives and the generated points are shifted and glued, based on the global descriptor, using a second neural network.

The present principles also relate to a device comprising a processor associated with a memory configured to implement the steps of the method above.

The present principles also relate to an encoder combining the aforementioned devices. The encoder is configured to end-to-end train the neural networks of the devices.

### 4. BRIEF DESCRIPTION OF DRAWINGS

The present disclosure will be better understood, and other specific features and advantages will emerge upon reading the following description, the description making reference to the annexed drawings, wherein:

FIG. 1 shows a method for performing an adaptive point cloud abstraction for subsequent machine tasks, according to a non-limiting embodiment of the present principles;

FIG. 2 shows a first embodiment of an encoder architecture where primitives are initialized randomly;

FIG. 3 illustrates a second non-limiting embodiment of an encoder architecture;

FIG. 4 illustrates a fourth embodiment of an encoder architecture according to the present principles;

FIG. 5 shows a non-limiting fifth embodiment of an encoder architecture;

FIG. 6 shows a non-limiting sixth embodiment of an encoder architecture;

FIG. 7 shows a non-limiting first embodiment of a decoder architecture;

FIG. 8 shows a non-limiting second embodiment of a decoder architecture; and

FIG. 9 shows an example architecture of a device which may be configured to implement a method described in relation to FIG. 1, according to a non-limiting embodiment of the present principles.

### 5. DETAILED DESCRIPTION OF EMBODIMENTS

The present principles will be described more fully hereinafter with reference to the accompanying figures, in which examples of the present principles are shown. The present principles may, however, be embodied in many alternate forms and should not be construed as limited to the examples set forth herein. Accordingly, while the present principles are susceptible to various modifications and alternative forms, specific examples thereof are shown by way of examples in the drawings and will herein be described in detail. It should be understood, however, that there is no intent to limit the present principles to the particular forms disclosed, but on the contrary, the disclosure is to cover all modifications, equivalents, and alternatives falling within the spirit and scope of the present principles as defined by the claims.

The terminology used herein is for the purpose of describing particular examples only and is not intended to be limiting of the present principles. As used herein, the singular forms “a”, “an” and “the” are intended to include the plural forms as well, unless the context clearly indicates otherwise. It will be further understood that the terms “comprises”, “comprising,” “includes” and/or “including” when used in this specification, specify the presence of stated features, integers, steps, operations, elements, and/or components but do not preclude the presence or addition of one or more other features, integers, steps, operations, elements, components, and/or groups thereof. Moreover, when an element is referred to as being “responsive” or “connected” to another element, it can be directly responsive or connected to the other element, or intervening elements may be present. In contrast, when an element is referred to as being “directly responsive” or “directly connected” to other element, there are no intervening elements present. As used herein the term “and/or” includes any and all combinations of one or more of the associated listed items and may be abbreviated as “/”.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element without departing from the teachings of the present principles.

Although some of the diagrams include arrows on communication paths to show a primary direction of communication, it is to be understood that communication may occur in the opposite direction to the depicted arrows.

Some examples are described with regard to block diagrams and operational flowcharts in which each block represents a circuit element, module, or portion of code which comprises one or more executable instructions for implementing the specified logical function(s). It should also be noted that in other implementations, the function(s) noted in the blocks may occur out of the order noted. For example, two blocks shown in succession may, in fact, be executed substantially concurrently or the blocks may sometimes be executed in the reverse order, depending on the functionality involved.

Reference herein to “in accordance with an example” or “in an example” means that a particular feature, structure, or characteristic described in connection with the example can be included in at least one implementation of the present principles. The appearances of the phrase in accordance with an example” or “in an example” in various places in the specification are not necessarily all referring to the same example, nor are separate or alternative examples necessarily mutually exclusive of other examples.

Reference numerals appearing in the claims are by way of illustration only and shall have no limiting effect on the scope of the claims. While not explicitly described, the present examples and variants may be employed in any combination or sub-combination.

3D point cloud data are essentially discrete samples of the surfaces of objects or scenes. To fully represent the real world with point samples, in practice, a large number of points is required. Therefore, the processing of such large-scale point clouds is computationally expensive, especially for consumer devices that have limited computational power, e.g., smartphones, tablets, and automotive navigation systems.

An important aspect of any kind of processing or inference on the point cloud is having efficient storage methodologies. To store and process the input point cloud at an affordable computational cost, one solution is to down-sample it first, where the down-sampled point cloud summarizes the geometry of the input point cloud while having much fewer points. The down-sampled point cloud is then fed to the subsequent machine task for further consumption. Another method is to summarize the point cloud data through point cloud abstraction, where the raw point cloud with millions of points is represented by a handful of primitives which provide a geometrical summary of the local regions in the point cloud and are easy to interpret for machines and humans. However, depending on the kind of downstream task, the required level of details needed to be retained by abstraction can vary drastically. Hence, it is beneficial to have an adaptive point cloud abstraction method that is task-aware and can successfully adapt to the required level of details and the required kind of summarization.

Raw point cloud data obtained from sensing modalities can be sparse and noisy and may need to first be processed for downstream tasks such as summarization, segmentation, compression, classification, etc. To facilitate these downstream tasks, methods and apparatuses performing an efficient point cloud abstraction to provide a new way to represent the raw point cloud as a combination of explicit (geometric primitives) and implicit (abstract codewords) features are disclosed.

Point cloud abstraction includes summarizing a raw point cloud through geometric primitives such as patches (restricted manifolds), volumetric shapes (cuboids, spheres, etc.), or sparse meshes. Regarding deep learning-based methods, two main strategies pertain to supervised and unsupervised point cloud abstraction (PCA). Supervised PCA refers to the setting where the training process assumes access to ground truth information about the primitives and point memberships to the primitives. In contrast, unsupervised PCA assumes access to the raw point cloud or a (trivially obtained) representation of the point cloud like mesh or octree. Since it is expensive to obtain ground truth information in lieu of the large number of points in the point cloud data, unsupervised point cloud processing approaches are preferred in the community, at some tolerable loss in performance.

Within unsupervised PCA, there exist several methods with which to abstract the raw point cloud data. These include (1) generating volume-based geometric shapes that enclose objects or various parts of objects in the point cloud; (2) generating patches that cover the surface area of an object in the point cloud; or (3) generating minimal water-tight meshes enclosing the objects in the point cloud. Most unsupervised (and supervised) PCA methods achieve satisfactory performance only for point cloud containing scans of single objects and perform poorly for scene level point clouds. Additionally, with these methods of abstraction, there is a loss of information about the details of the objects at finer scales. The present principles address both of these issues through a novel architecture.

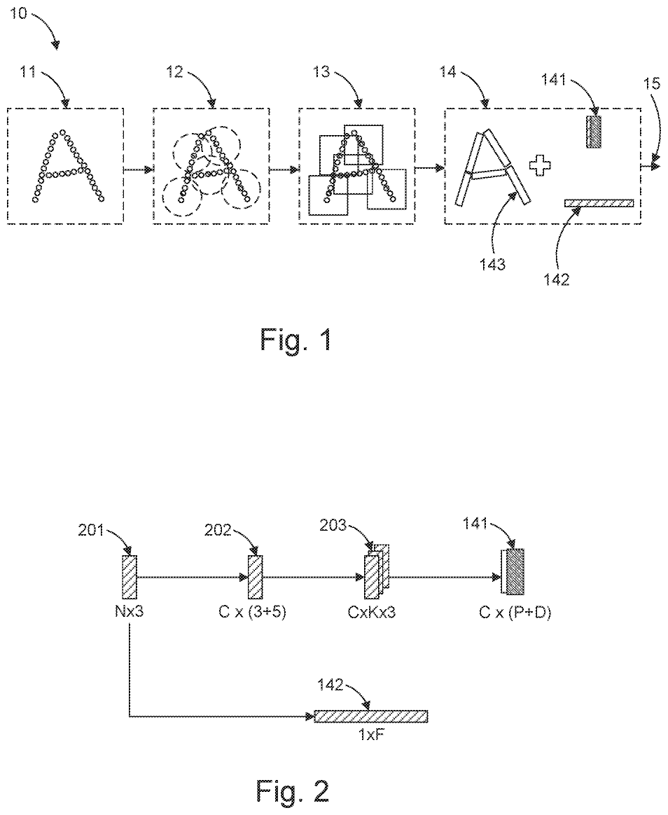

FIG. 1 shows a method 10 performing an adaptive point cloud abstraction for subsequent machine tasks, according to a non-limiting embodiment of the present principles. A subsequent machine task may be, for instance, another abstraction, compression, classification, segmentation, etc. of the point cloud. At a step 11, a point cloud is obtained. In the example of FIG. 1, for clarity, a 2D point cloud is represented. The present principles apply without loss of generality to point clouds of any number of dimensions, in particular to 3D point clouds. Given an input point cloud X with N points, at a step 12, a subset of C points (C<N) is selected and a primitive set which denotes the parameters regarding the shapes and locations of the primitives is initialized. The selected C points are used as centroids to specify the locations of primitives. At a step 13, local point sets are made around each centroid point by grouping points in its neighborhood using an existing method. At step 14, each local point set is fed into a neural network architecture to obtain updated primitive parameters 143 for that local point set along with a codeword vector that contains additional features not captured by the primitive. The codeword vector comprises local features 141 and global features 142. The output 15 of method 10 comprises these C “primitives+codewords” and is used to feed into additional modules for further downstream tasks. Adaptive point cloud abstraction method 10 is integrated with the subsequent task and trained in an end-to-end manner such that method 10 is task-aware, i.e., adaptive to the machine task.

FIG. 2 shows a first embodiment of an encoder architecture in accordance with the present disclosure where primitives are initialized randomly. Given an input point cloud 201 with N points (e.g., a point having three-dimensional coordinates in the examples of FIGS. 2-8), a module selects C points 202 from the point cloud, for example randomly. The shape parameters for C primitives (a primitive having 5 parameters in the examples of FIGS. 2-8) are initialized in a fixed pre-defined manner depending on the type of primitive being used (manifold or volumetric). These initialized primitives are placed at the C points selected earlier through random sampling. Then, local point sets 203 are constructed by a set of around for each primitive using a ball query procedure of fixed length. The overall point cloud is fed into a neural network extracting (for instance, the PointNet architecture as described in “PointNet: Deep learning on point sets for 3D classification and segmentation,” in proc. IEEE Conference on Computer Vision and Pattern Recognition, pp. 652-660, 2017) to extract a global codeword vector 142 from the point cloud. Local point sets are also fed into a separate neural network, for instance the PointNet architecture, which extracts local codewords 141 for all point sets along with updated primitive parameters.

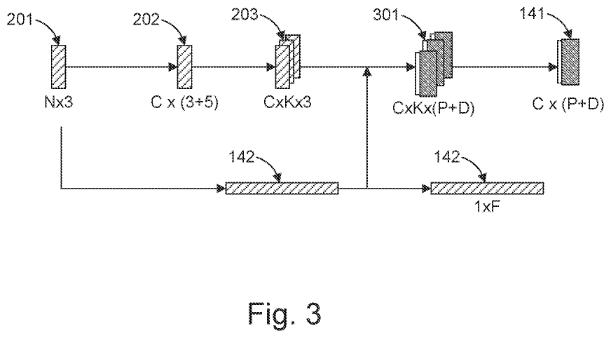

FIG. 3 illustrates a second non-limiting embodiment of an encoder architecture in accordance with the present disclosure. The difference between this second embodiment and the first embodiment of FIG. 2 lies in the architecture of the neural network for extracting local features. This architecture, herein called ‘P-Net’, is similar to PointNet, but the global codeword 142 is fed as an input to the last Multi-Layers Perception (MLP) of original PointNet to obtain richer local codewords 301 that are also aware of the global topology of the point cloud. The ‘P-Net’ extracts the better local codewords 301 and these newer codewords are used for further processing and primitive generation.

Iin a third embodiment, similar to the second embodiment of FIG. 3, a different initial sampling of the raw point cloud is used to initialize the locations of the primitive. Instead of random sampling, the initial centroids are selected through farthest point sampling (as described in “The Farthest point strategy for progressive image sampling,” IEEE Trans. on Image Processing, vol. 6, no. 9, pp. 1306-1315, 1997) to distribute the centroids evenly and in the diverse local regions of the point cloud.

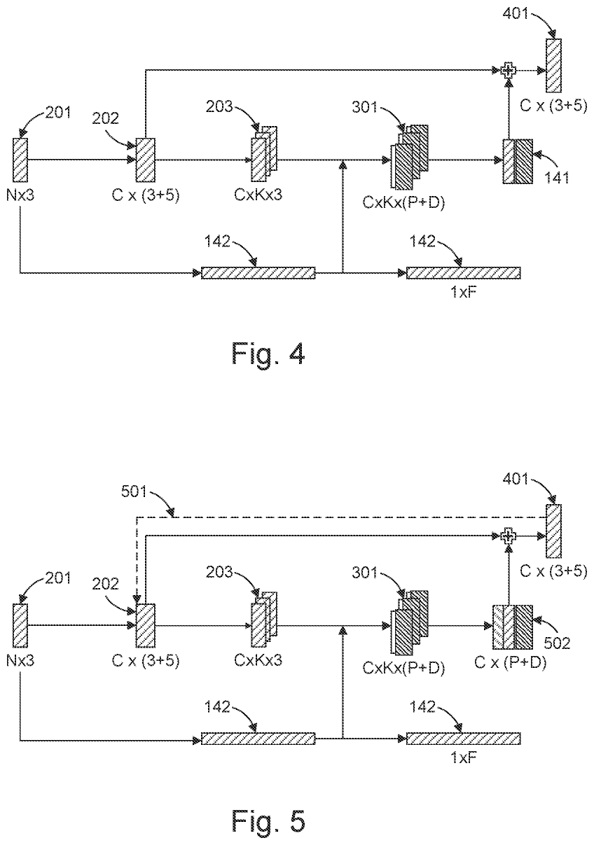

FIG. 4 illustrates a fourth embodiment of an encoder architecture according to the present principles. Instead of generating new network parameters altogether like in the preceding embodiments, this embodiment computes a correction to the primitive parameters to move the primitives centroid to better points and provide a better overall shape of the primitive. To achieve this, the output of the local P-Net is added to the primitive parameters 202 and this summing output 401 acts as a correction upon the primitive parameters that were initialized.

FIG. 5 shows a non-limiting fifth embodiment of an encoder architecture. The primitive parameter correction procedure from the fourth embodiment shifts the primitives 401 from left to right, thereby correcting their shape. This correction procedure is potentially repeated multiple times in a recurrent fashion through a feedback loop 501 that connects the output of the local P-Net to its input and starts again by constructing new local point sets through the ball query procedure. This architecture provides a refinement strategy without the need for any additional neural network modules and, thus, the number of parameters of the network that need training remains the same.

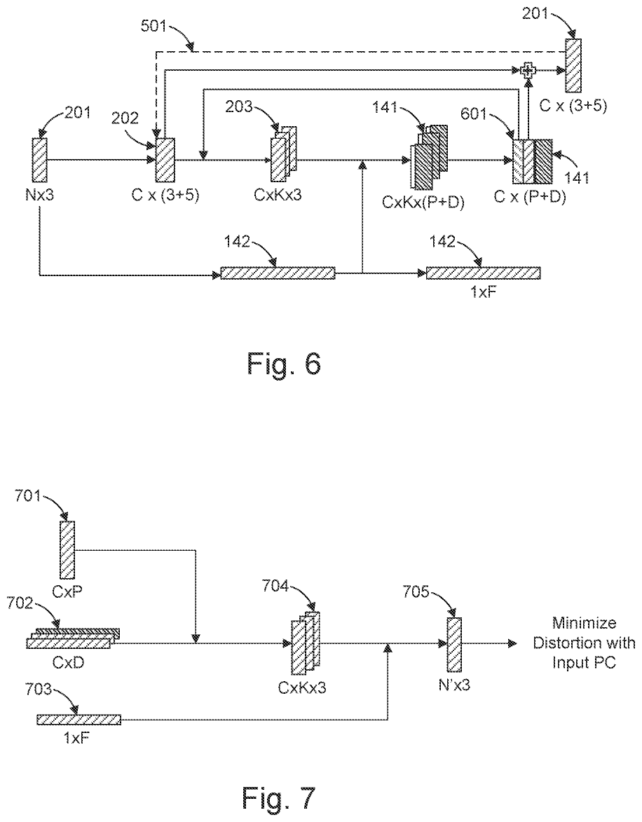

FIG. 6 shows a non-limiting sixth embodiment of an encoder architecture in accordance with the present disclosure. All of the aforementioned embodiments provide ways to refine the parameters of the primitives. However, the quality of reconstruction also depends on the points that are included in the ball query procedure. Because of that, it is also beneficial to update the query range while refining the primitives. To achieve this, an additional output vector 601 is generated from the local P-Net which acts as a (separate) query range update for the ball query done for each primitive 202.

It is generally considered beneficial to have a modular architecture of neural networks, each module being reserved for a specific task. With this motivation, a seventh embodiment of an encoder architecture reserves the local P-Net architecture for extracting only the features (local codewords as implicit features and correction of primitive parameters as explicit features), and uses a separate neural network, herein called M-Net, to compute the query update for ball query of each primitive.

FIG. 7 shows a non-limiting first embodiment of a decoder architecture in accordance with the present disclosure. A decoder performs the task of point cloud reconstruction from the primitives 701 and the local codewords 702 and global codewords 703 to generate a point cloud that is a close fit to the original one while retaining as much detail as possible. Given C primitive parameters and the codewords, a sampling is performed (e.g., a random sampling) to generate K points associated with each primitive 704 (on the primitive surface for manifold primitives, and within a volume for volumetric primitives). Then the generated points and the primitive parameters are fed into a neural network module that glues the primitives together (and shifts the associated points) to generate vectors 705 according to the global codeword to match the global topology and for global uniformity.

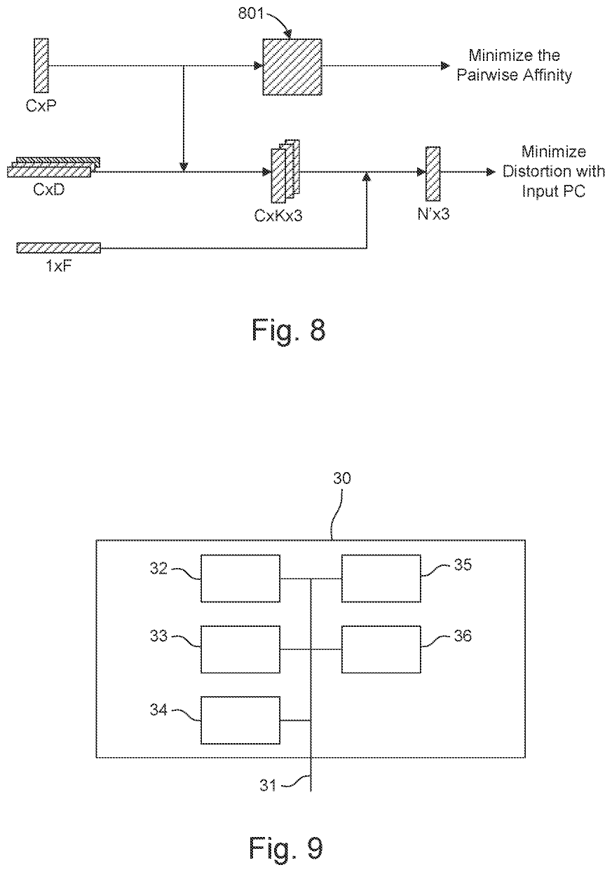

FIG. 8 shows a non-limiting second embodiment of a decoder architecture in accordance with the present disclosure. To achieve diversity of information that each primitive captures and to reduce overlap between the regions that the primitive summarizes, the architecture of this embodiment comprises an additional module that computes and penalizes the affinity matrix 801 between the primitives. This affinity matrix 801 is calculated entry-wise as the pairwise inner product between the normal vectors of all primitives for the case of manifold primitives. For volumetric primitives, the affinity is calculated as the pairwise volume overlap between all the volumetric primitives.

In a variant, instead of reconstructing the point cloud, representative primitives are generated for each object. This can be achieved by first using volumetric primitives and then controlling the number of primitives such that each volumetric primitive only encloses the point cloud subset for one object. The number of primitives can be controlled by generating the primitives in a hierarchical fashion, or by employing a merging/splitting mechanism. The overall mechanism in this variant can also be tuned to achieve part segmentation instead of object segmentation.

In an embodiment, a primitive generation method initializes the primitive set including a combination of various types of manifold-based or volumetric primitives and refines them through the proposed encoder architectures.

In another embodiment, a primitive generation method initializes an initial primitive set at the first stage and refines the initial primitive set through the encoder architecture until a predefined condition is satisfied. After a few recurrent iterations, the method initializes additional primitives, appends to the existing primitive set, and refines the larger updated primitive set to obtain a better fit on the point cloud. The process is repeated as necessary.

In another embodiment, a method, based on some pre-defined criterion either, (1) splits a primitive into two smaller primitives of the same kind and updates the primitive set to append the new primitives to the set and removes the older primitive, or (2) merges two primitives of the same kind into one larger primitive and updates the primitive set by removing the older primitives and adding the newer one. Then the method continues by keeping refining the primitives via the proposed encoder architectures several times, as necessary.

FIG. 9 shows an example architecture of a device 30 which may be configured to implement a method described in relation to FIG. 1. Encoders of FIGS. 2-6 and/or decoders of FIGS. 7 and 8 may implement this architecture. Alternatively, each module of encoders and/or decoders according to the present principles may be a device according to the architecture of FIG. 9, linked together, for instance, via their bus 31 and/or via I/O interface 36.

Device 30 comprises the following elements that are linked together by a data and address bus 31:
a microprocessor 32 (or CPU), which is, for example, a DSP (or Digital Signal Processor);
a ROM (or Read Only Memory) 33;
a RAM (or Random Access Memory) 34;
a storage interface 35;
an I/O interface 36 for reception of data to transmit, from an application; and
a power supply, e.g., a battery (not shown).

In accordance with an example, the power supply is external to the device. In each of the mentioned memory, the word «register» used in the specification may correspond to an area of small capacity (some bits) or to very large area (e.g., a whole program or large amount of received or decoded data). The ROM 33 comprises at least a program and parameters. The ROM 33 may store algorithms and instructions to perform techniques in accordance with present principles. When switched on, the CPU 32 uploads the program in the RAM and executes the corresponding instructions.

The RAM 34 comprises, in a register, the program executed by the CPU 32 and uploaded after switch-on of the device 30, input data in a register, intermediate data in different states of the method in a register, and other variables used for the execution of the method in a register.

The implementations described herein may be implemented in, for example, a method or a process, an apparatus, a computer program product, a data stream, or a signal. Even if only discussed in the context of a single form of implementation (for example, discussed only as a method or a device), the implementation of features discussed may also be implemented in other forms (for example a program). An apparatus may be implemented in, for example, appropriate hardware, software, and firmware. The methods may be implemented in, for example, an apparatus such as, for example, a processor, which refers to processing devices in general, including, for example, a computer, a microprocessor, an integrated circuit, or a programmable logic device. Processors also include communication devices, such as, for example, computers, cell phones, portable/personal digital assistants (“PDAs”), and other devices that facilitate communication of information between end-users.

In accordance with examples of the present disclosure, the device 30 belongs to a set comprising:
a mobile device;
a communication device;
a game device;
a tablet (or tablet computer);
a laptop;
a still picture or a video camera, for instance equipped with a depth sensor;
a rig of still picture or video cameras;
an encoding chip;
a server (e.g., a broadcast server, a video-on-demand server or a web server).

Implementations of the various processes and features described herein may be embodied in a variety of different equipment or applications, particularly, for example, equipment or applications associated with data encoding, data decoding, view generation, texture processing, and other processing of images and related texture information and/or depth information. Examples of such equipment include an encoder, a decoder, a post-processor processing output from a decoder, a pre-processor providing input to an encoder, a video coder, a video decoder, a video codec, a web server, a set-top box, a laptop, a personal computer, a cell phone, a PDA, and other communication devices. As should be clear, the equipment may be mobile and even installed in a mobile vehicle.

Additionally, the methods may be implemented by instructions being performed by a processor, and such instructions (and/or data values produced by an implementation) may be stored on a processor-readable medium such as, for example, an integrated circuit, a software carrier or other storage device such as, for example, a hard disk, a compact diskette (“CD”), an optical disc (such as, for example, a DVD, often referred to as a digital versatile disc or a digital video disc), a random access memory (“RAM”), or a read-only memory (“ROM”). The instructions may form an application program tangibly embodied on a processor-readable medium. Instructions may be, for example, in hardware, firmware, software, or a combination. Instructions may be found in, for example, an operating system, a separate application, or a combination of the two. A processor may be characterized, therefore, as, for example, both a device configured to carry out a process and a device that includes a processor-readable medium (such as a storage device) having instructions for carrying out a process. Further, a processor-readable medium may store, in addition to or in lieu of instructions, data values produced by an implementation.

As will be evident to one of skill in the art, implementations may produce a variety of signals formatted to carry information that may be, for example, stored or transmitted. The information may include, for example, instructions for performing a method, or data produced by one of the described implementations. For example, a signal may be formatted to carry as data the rules for writing or reading the syntax of a described embodiment, or to carry as data the actual syntax-values written by a described embodiment. Such a signal may be formatted, for example, as an electromagnetic wave (for example, using a radio frequency portion of spectrum) or as a baseband signal. The formatting may include, for example, encoding a data stream and modulating a carrier with the encoded data stream. The information that the signal carries may be, for example, analog or digital information. The signal may be transmitted over a variety of different wired or wireless links, as is known. The signal may be stored on a processor-readable medium.

A number of implementations have been described. Nevertheless, it will be understood that various modifications may be made. For example, elements of different implementations may be combined, supplemented, modified, or removed to produce other implementations. Additionally, one of ordinary skill will understand that other structures and processes may be substituted for those disclosed and the resulting implementations will perform at least substantially the same function(s), in at least substantially the same way(s), to achieve at least substantially the same result(s) as the implementations disclosed. Accordingly, these and other implementations are contemplated by this application.

1. A method for adaptively abstracting a point cloud, the method comprising:
initializing a set of primitives associated with a query shape and a set of query parameters;
for each primitive, accessing a local point set using the set of query parameters and the query shape associated with the primitive;
for each local point set, determining, using a first neural network, a descriptor vector comprising a sub-vector for a primitive update and a sub-vector for a local descriptor; and
updating the set of primitives based on the descriptor vector for each local point set.

2. The method of claim 1, wherein a global descriptor is used as an input for determining the sub-vector for the local descriptor, the global descriptor determined using a second neural network.

3. The method of claim 1, wherein the set of primitives is initialized by farthest point sampling the point cloud.

4. The method of claim 1, wherein updating the set of primitives is performed using the sub-vector for the primitive update.

5. The method of claim 1, wherein at least two types of primitives are initialized by initializing at least two distinct query shapes and wherein the at least two distinct query shapes are used to learn a combination of primitives from the point cloud.

6. A device comprising a processor associated with a memory, wherein the processor is configured to:
initialize a set of primitives associated with a query shape and a set of query parameters;
for each primitive, access a local point set using the set of query parameters and the query shape associated with the primitive;
for each local point set, determine, using a first neural network, a descriptor vector comprising a sub-vector for a primitive update and a sub-vector for a local descriptor; and
update the set of primitives based on the descriptor vector for each local point set.

7. The device of claim 6, wherein a global descriptor is used as an input for determining the sub-vector for the local descriptor, the global descriptor determined using a second neural network.

8. The device of claim 6, wherein the processor is configured to initialize set of primitives by farthest point sampling the point cloud.

9. The device of claim 6, wherein the processor is configured to update the set of primitives using the sub-vector for the primitive update.

10. The device of claim 6, wherein the processor is configured to initialize at least two types of primitives by initializing at least two distinct query shapes and to learn a combination of primitives from the point cloud using the at least two distinct query shapes.

11. A method for reconstructing a point cloud from a set of primitives comprising a local descriptor and a global descriptor, the method comprising:
determining a sampling distribution in a space of the point cloud based on the primitives;
determining distribution parameters, based on the local descriptor, using a first neural network;
generating points of the primitives from the distribution parameters; and
shifting and gluing the set of primitives and the generated points, based on the global descriptor, using a second neural network.

12. The method of claim 11, further comprising:
computing an affinity matrix between the primitives as a pairwise inner product of normal vectors of the respective primitives.

13. A device comprising a processor associated with a memory, the processor being configured to, for a set of primitives comprising a local descriptor and a global descriptor:
determine a sampling distribution in a space of the point cloud based on the primitives;
determine distribution parameters, based on the local descriptor, using a first neural network;
generate points of the primitives from the distribution parameters; and
shift and glue the set of primitives and the sampled points, based on the global descriptor, using a second neural network.

14. The device of claim 13, wherein the processor is further configured to:
compute an affinity matrix between the primitives as a pairwise inner product of normal vectors of the respective primitives.

15. (canceled)
